(19) United States
(12) Patent Application Publication
(10) Pub. No.: US 2018/0209777 A1
(43) Pub. Date: Jul. 26, 2018

(54) LIGHTING UNIT AND OPTICAL COHERENCE TOMOGRAPHY SYSTEM USING THE SAME

(71) Applicant: HON HAI PRECISION INDUSTRY CO., LTD., New Taipei (TW)

(72) Inventors: JUIN-HONG LIN, New Taipei (TW); CHAO-TSANG WEI, New Taipei (TW); HO-CHIANG LIU, New Taipei (TW)

(21) Appl. No.: 15/876,114

(22) Filed: Jan. 20, 2018

(30) Foreign Application Priority Data
Jan. 24, 2017 (TW) 106102635

(51) Int. Cl. G01B 9/02

(52) U.S. Cl. CPC G01B 9/02005; G01B 9/02091

(57) ABSTRACT

The disclosure relates to a lighting unit includes a light source and an optical filter. The light source emits a first light beam with a continuous wavelength ranged from about 600 nanometers to about 1500 nanometers. The optical filter is located in the propagation path of the first light beam and allowing the first light with a certain wavelength to pass through. The disclosure also relates to an optical coherence tomography system using the same.

### CROSS-REFERENCE TO RELATED APPLICATIONS

This application claims all benefits accruing under 35 U.S.C. § 119 from Taiwan Patent Application No. 106102635, filed on Jan. 24, 2017, in the Taiwan Intellectual Property Office, the contents of which are hereby incorporated by reference.

### BACKGROUND

### 1. Technical Field

The subject matter herein generally relates to lighting unit.

### 2. Description of Related Art

Optical Coherence Tomography (OCT) is an imaging technique that uses coherent light to capture micrometer-resolution, two- and three-dimensional images from within optical scattering media (e.g., biological tissue).

In prior art, the light sources used by the OCT are mostly near-infrared broad-band light sources with wavelength of about 600 nm to about 1300 nm, such as ultra-high brightness diodes, broadband lasers, and photonic crystal fiber light sources (PCF). However, these light sources have the problem of insufficient light intensity and constant bandwidth.

What is needed, therefore, is to provide a lighting unit which can overcome the shortcomings as described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic section view of a first exemplary embodiment of a lighting unit.

FIG. 2 is a spectrum of the first exemplary embodiment of the lighting unit.

FIG. 3 is a schematic section view of a second exemplary embodiment of a lighting unit.

FIG. 4 is a schematic section view of a third exemplary embodiment of a lighting unit.

FIG. 5 is a schematic section view of a fourth exemplary embodiment of a lighting unit.

FIG. 6 is a spectrum of the fourth exemplary embodiment of the lighting unit.

FIG. 7 is a schematic section view of a fifth exemplary embodiment of an optical coherence tomography system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated to be better illustrate details and features. The description is not to considered as limiting the scope of the embodiments described herein.

Several definitions that apply throughout this disclosure will now be presented.

The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

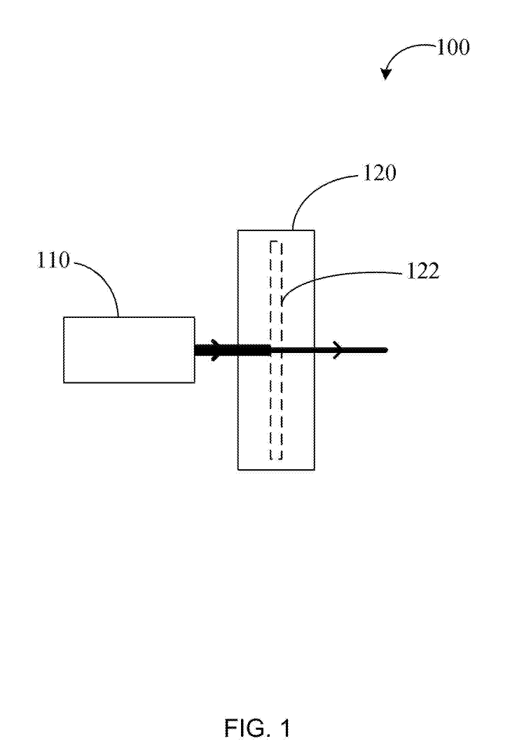

Referring to FIG. 1, a lighting unit 100 of a first exemplary embodiment includes a light source 110 and an optical filter 120. The lighting unit 100 is used in an optical coherence tomography system.

The light source 110 emits a first light beam. The optical filter 120 is located in the propagation path of the first light beam and filters the first light beam.

The light source 110 can at least emit light with a continuous wavelength in a range from about 600 nanometers to about 1500 nanometers. The structure of the light source 110 is not limited and can be selected according to need, such as white light-emitting diode (LED), tungsten lamp, or cold cathode lamp. The intensity of the light beam generated from the light sources 110 is higher than that of the light source commonly used in the current optical coherence tomography system, so the signal-to-noise ratio of the optical coherence tomography system can be improved by using the light source 110.

The optical filter 120 is located in the propagation path of the first light beam and allows the light with a certain wavelength to pass through. In one exemplary embodiment, the optical filter 120 includes a single narrow-band filter 122. The center wavelength and half-width of the narrow-band filter 122 can be selected according to need.

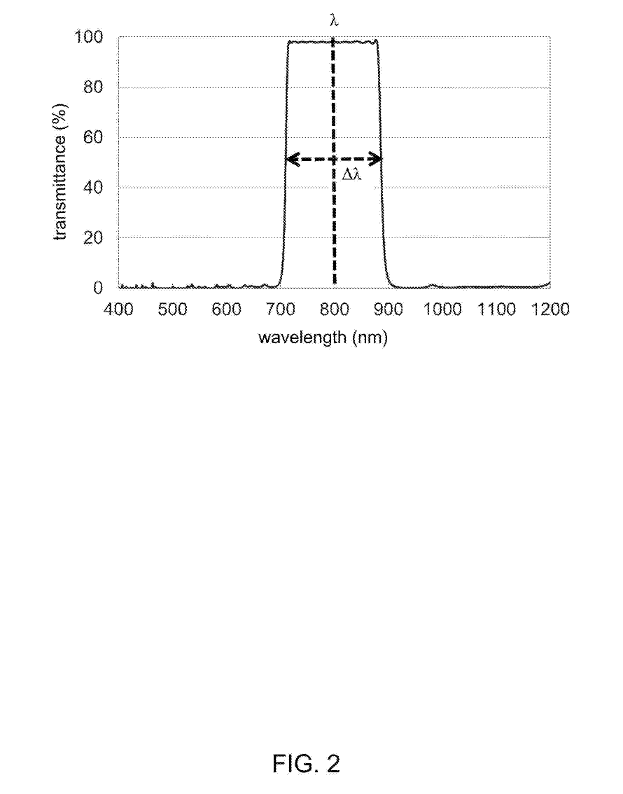

Referring to FIG. 2, the λ, is the center wavelength of the optical filter 120. The λ, can be in a range from about 600 nanometers to about 1,500 nanometers, in one embodiment, λ, is about 800 nanometers. The center wavelength is determined by the biological tissues to be observed. When the wavelength is less than 600 nanometers, the light wave is easily absorbed by Melanin and Hemoglobin, and when the wavelength is higher than 1300 nanometers, the light wave is easily absorbed by water molecules in biological tissues. The Δλ is the full width at half maximum (FWHM) of the optical filter 120, and can be ranged from about 10 nanometers to about 500 nanometers. In one embodiment, the Δλ is about 200 nanometers.

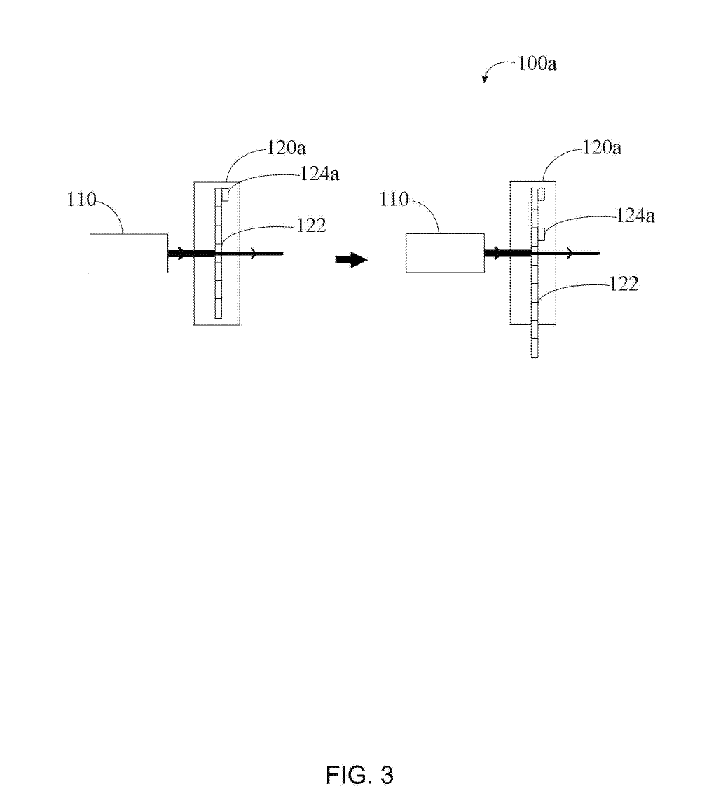

Referring to FIG. 3, a lighting unit 100a of a second exemplary embodiment includes a light source 110 and an optical filter 120a. The lighting unit 100a is used in an optical coherence tomography system.

The lighting unit 100a in the second exemplary embodiment shown in FIG. 3 is similar to the lighting unit 100 in the first exemplary embodiment shown in FIG. 1, except that the optical filter 120a further includes a plurality of narrow-band filters 122 with different center wavelengths and different half-widths and a control device 124a used to select one of the narrow-band filters 122 and dispose the selected narrow-band filter 122 on the propagation path of the first light beam.

In one exemplary embodiment, the plurality of narrow-band filters 122 can be coplanar, and adjacent narrow-band filters 122 are connected with each other to form a single layered structure. The control device 124a is connected to the layered structure and moves the layered structure to let the selected narrow-band filter on the propagation path of the first light beam by pulling and pushing.

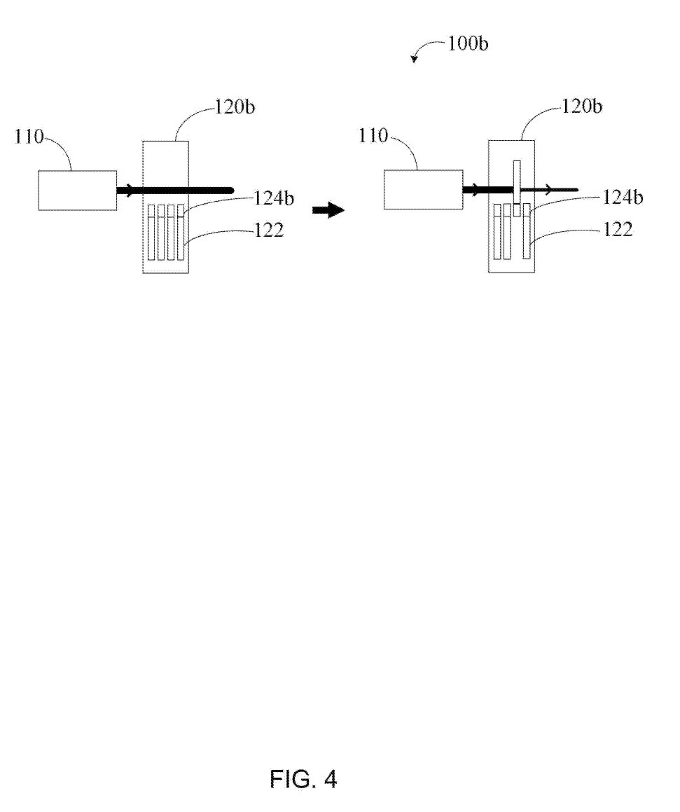

Referring to FIG. 4, a lighting unit 100b of a third exemplary embodiment includes a light source 110 and an optical filter 120b. The lighting unit 100b is used in an optical coherence tomography system.

The lighting unit 100b in the third exemplary embodiment shown in FIG. 4 is similar to the lighting unit 100 in the first exemplary embodiment shown in FIG. 1, except that the optical filter 120b further includes a plurality of control devices 124b with different center wavelengths and different half-widths and a plurality of control devices 124b. The narrow-band filters 122 are stacked with respect to each other to form a multi-layered structure and can be respectively moved or rotated by the plurality of control devices 124b. The control devices 124b are used to select one of the narrow-band filters 122 and dispose the selected narrow-band filter 122 on the propagation path of the first light beam. In one exemplary embodiment, each of the control devices 124b is connected with one narrow-band filter 122. The control devices 124b can rotate the connected narrow bandpass filter so that the connected narrow bandpass filter can be located in or moved away from the propagation path of the first light beam.

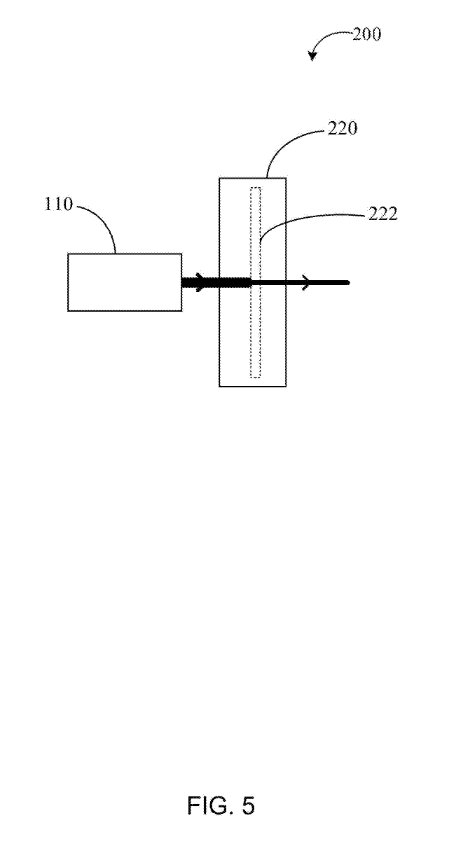

Referring to FIG. 5, a lighting unit 200 of a fourth exemplary embodiment includes a light source 110 and an optical filter 220. The lighting unit 200 is used in an optical coherence tomography system.

The lighting unit 200 in the fourth exemplary embodiment shown in FIG. 5 is similar to the lighting unit 100 in the first embodiment shown in FIG. 1, except that the optical filter 220 includes a single multi-band filter 222 having at least two passbands. In one exemplary embodiment, the multi-band filter 222 is a single sheet of light filter that only allows the light with a wavelength of 610 nm-710 nm and 890 nm-990 nm to pass through. The size and structure of the double band filter is not limited and can be designed according to need.

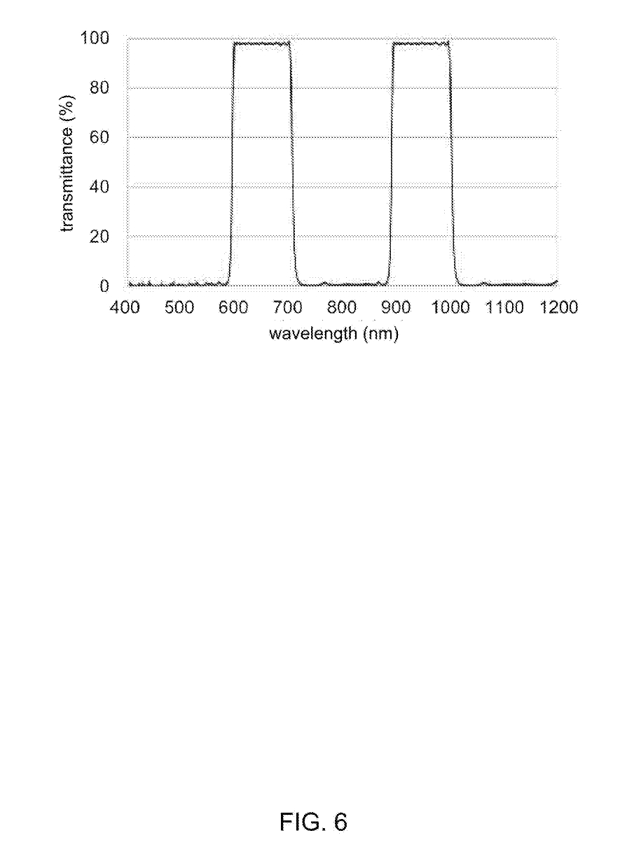

Referring to FIG. 6, λ1 is the first center wavelength of the multi-band filter 222, and λ2 is the second center wavelength of the multi-band filter 222. In one embodiment, λ1 is about 650 nanometers, λ2 is about 950 nanometers. Δλ1 is the first full width at half maximum (FWHM) of the multi-band filter 222, and Δλ2 is the second full width at half maximum (FWHM) of the multi-band filter 222. Δλ1 and Δλ2 can be ranged from about 10 nanometers to about 500 nanometers. In one embodiment, Δλ1 and Δλ2 is about 100 nanometers.

The lighting unit 100, 100a, 100b, 200 has following advantages. First, the intensity of light beam emitted by the light sources is higher than that of the light source commonly used in the current optical coherence tomography system, so the signal-to-noise ratio of the optical coherence tomography system can be improved by using the light source. Second, the light sources cooperated with the optical filter can obtain light waves with different center wavelengths so as to reduce the absorption of light by the biological tissues. Third, the light sources cooperated with the optical filter can obtain light waves with different FWHM so as to adjust the longitudinal resolution of the optical coherent tomography system.

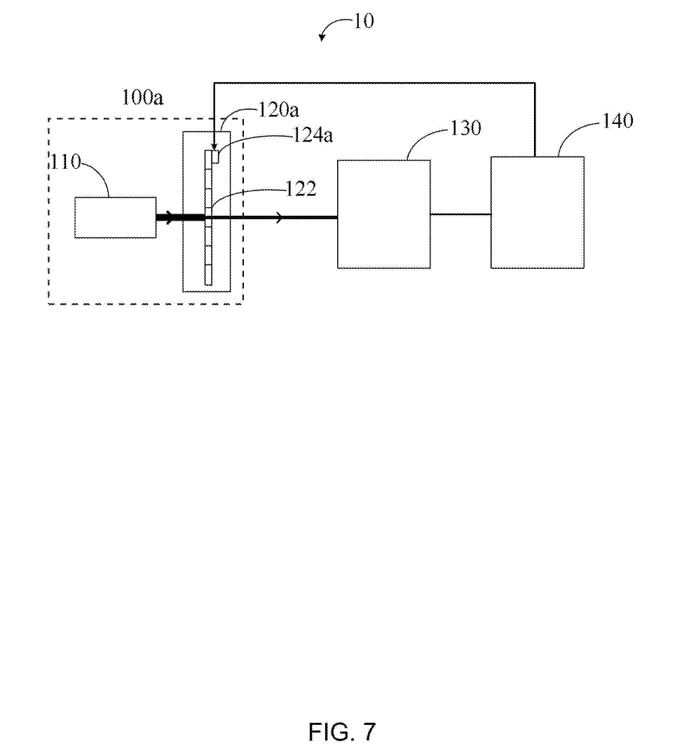

Referring to FIG. 7, an optical coherence tomography system 10 of a fifth exemplary embodiment is provided. The optical coherence tomography system 10 includes a lighting unit 100a, an interferometer 130, and a signal processor 140. The lighting unit 100a, the interferometer 130, and the signal processor 140 are connected with each other by wire or wireless. The lighting unit 100a in the fifth exemplary embodiment also can be replaced by the lighting unit 100 in the first exemplary embodiment, the lighting unit 100b in the third exemplary embodiment, or the lighting unit 200 in the fourth exemplary embodiment.

The lighting unit 100a is used to provide a low-coherence light beam required for optical coherent tomography. The lighting unit 100a includes a light source 110 and an optical filter 120a. The light source 110 is used to emit a first light beam and the optical filter 120a is located in the propagation path of the first light beam and filters the first light beam to obtain a second light beam. The optical filter 120a includes a plurality of narrow-band filters 122 and a control device 124a. The control device 124a used to select one of the narrow-band filters 122 according the control signal and dispose the selected narrow-band filter 122 on the propagation path of the first light beam. The control signal can be sent by the signal processor 140 and received by the control device 124a.

The interferometer 130 is used to obtain the interference signal of the sample arm and the reference arm. The interferometer 130 includes an optical interferometer, which can be a Wilson interferometer.

The signal processor 140 is used to receive the interference signal obtained by the interferometer 130 and process the interference signal to obtain the image information of the observed sample. For example, the signal processor 140 converts the received optical signal (interference signal) into an electrical signal, and processes the electrical signal, such as filtering, amplification and the like, and then reconstructs to obtain the image information of the observed sample.

The signal processor 140 is also used to control the control device 124a to select a certain narrow-band filter 122 and dispose the selected narrow-band filter 122 on the propagation path of the first light beam. For example, the signal processor 140 sends a control signal to the control device 124a to gradually increase or decrease the center wavelength or the full width at half maximum of the optical filter 120a by changing different narrow-band filters 122.

The embodiments shown and described above are only examples. Even though numerous characteristics and advantages of the present technology have been set forth in the forego description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Depending on the embodiment, certain of the steps of methods described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A lighting unit, comprising:
a light source emitting a first light beam with a continuous wavelength in a range from about 600 nanometers to about 1500 nanometers; and
an optical filter, wherein the optical filter comprises:
a plurality of narrow-band filters with different center wavelengths and different half-widths; and
a control device, configured to select one of the plurality of narrow-band filters to form a selected narrow-band filter and dispose the selected narrow-band filter on a propagation path of the first light beam.

2. The lighting unit of claim 1, wherein the light source is white light-emitting diode, tungsten lamp, or cold cathode lamp.

3. The lighting unit of claim 1, wherein a center wavelength of the optical filter ranges from about 600 nanometers to about 1,500 nanometers.

4. The lighting unit of claim 3, wherein the center wavelength of the optical filter is about 800 nanometers.

5. The lighting unit of claim 1, wherein a full width at half maximum of the optical filter ranges from about 10 nanometers to about 500 nanometers.

6. The lighting unit of claim 5, wherein the full width at half maximum of the optical filter is about 200 nanometers.

7. The lighting unit of claim 1, wherein the plurality of narrow-band filters is coplanar, and adjacent two of the plurality of narrow-band filters are connected with each other to form a layered structure, the control device is connected to the layered structure and moves the layered structure to let the selected narrow-band filter on the propagation path of the first light beam by pulling and pushing.

8. The lighting unit of claim 1, wherein the plurality of narrow-band filters are stacked with respect to each other, the control device is connected with the plurality of narrow-band filters and disposes the selected narrow-band filter on the propagation path of the first light beam by moving or rotating the selected narrow-band filter.

9. A lighting unit, comprising:
a light source emitting a first light beam with a continuous wavelength in a range from about 600 nanometers to about 1500 nanometers; and
an optical filter on a propagation path of the first light beam, the optical filter comprises a multi-band filter having at least two passbands.

10. The lighting unit of claim 9, wherein a first center wavelength of the multi-band filter is 650 nanometers, and a second center wavelength of the multi-band filter is 950 nanometers.

11. The lighting unit of claim 9, wherein a first full width at half maximum of the multi-band filter and a second full width at half maximum of the multi-band filter range from 10 nanometers to 500 nanometers.

12. An optical coherence tomography system, comprising:
a lighting unit, wherein the lighting unit comprises:
a light source emitting a first light beam with a continuous wavelength in a range from about 600 nanometers to about 1500 nanometers; and
an optical filter, wherein the optical filter comprises:
a plurality of narrow-band filters with different center wavelengths and different half-widths; and
a control device, configured to select one of the plurality of narrow-band filters to form a selected narrow-band filter and dispose the selected narrow-band filter on a propagation path of the first light beam;
an interferometer configured to obtain an interference signal of a sample arm and a reference arm; and
signal processor configured to receive the interference signal and process the interference signal to obtain an image information of a observed sample.

13. The optical coherence tomography system of claim 12, wherein the light source is white light-emitting diode, tungsten lamp, or cold cathode lamp.

14. The optical coherence tomography system of claim 12, wherein a center wavelength of the optical filter ranges from about 600 nanometers to about 1,500 nanometers.

15. The optical coherence tomography system of claim 12, wherein a full width at half maximum of the optical filter ranges from about 10 nanometers to about 500 nanometers.

16. The optical coherence tomography system of claim 12, wherein the plurality of narrow-band filters is coplanar, and adjacent two of the plurality of narrow-band filters are connected with each other to form a layered structure, the control device is connected to the layered structure and moves the layered structure to let the selected narrow-band filter on the propagation path of the first light beam by pulling and pushing.

17. The optical coherence tomography system of claim 12, wherein the plurality of narrow-band filters are stacked with respect to each other, the control device is connected with the plurality of narrow-band filters and disposes the selected narrow-band filter on the propagation path of the first light beam by moving or rotating the selected narrow-band filter.
